(19) United States
(12) Patent Application Publication
(10) Pub. No.: US 2007/0238565 A1
(43) Pub. Date: Oct. 11, 2007

(54) Draper belt having improved durability

(76) Inventor: Ron Marler, Halstead, KS (US)

Correspondence Address: WILDMAN HARROLD ALLEN & DIXON, 225 WEST WACKER DRIVE, SUITE 2800, CHICAGO, IL, 60606, US

(21) Appl. No.: 11/389,946

(22) Filed: Mar. 27, 2006

(51) Int. Cl. F16G 1/00; F16G 9/00

(52) U.S. Cl. 474/237

(57) ABSTRACT

A novel wide-aspect endless conveyor belt, known as a draper belt, is disclosed and claimed. The belt is provided with reinforcing plys extending spanwise inwardly from each belt edge. Cleats, oriented spanwise of the belt, are each provided with cleat bases of extended dimension to extend the region of the belt and the cleat which are subjected to stress and strain as the cleat and belt turn over a mounting roller.

This invention relates to conveyor belts, and more particularly, concerns wide-aspect conveyor belts known as draper belts having improved durability and service life.

Conveyor belts have been long been used in industry to rapidly move large amounts of materials. Conveyor belts are used to move logs, pulp, paper, sand, gravel, aggregate, food, mine ore, construction materials, packages, grain, and the products of various manufacturing processes.

One important conveyor belt market involves the agricultural business. Wide-aspect belts are extensively used in farm machinery, especially harvesting implements. See U.S. Pat. Nos. 4,371,580 and 4,518,647. For example, a farm implement known as a swather may be provided with an elongated cutter bar to cut grass, wheat, oats, barley, rice, canola or other grains. Conveyor belts known as draper belts are located immediately behind the cutter bar to convey the cut materials to crimp rollers or other processing subsystems, or to the ground.

These draper belts must operate for long periods of time under adverse environmental conditions. Heat, cold, dirt, vibration and equipment misalignment can strain these belts and substantially shorten their service life.

It is accordingly an object of the present invention to provide draper belting having improved durability and consequently lengthened service life.

It is a more specific object of the invention to provide a draper belt having improved construction at its edges so as to increase its durability and lengthened service life.

It is another specific object of the invention to provide draper belting having an improved cleat design so as to increase the belting durability and lengthening its service life.

Other objects and advantages of the invention will become apparent upon reading the following detailed description and upon reference to the drawings. Throughout the drawings, like reference numerals refer to like parts.

### BRIEF DESCRIPTION OF THE DRAWINGS

FIG. 1 is a plan view of selected portions of a swather farm implement having a set of draper or material conveyor belts.

FIG. 2 is a side elevational view showing, in schematic form, portions of the swather farm implement shown in FIG. 1.

FIG. 3 is a perspective view of portions of the swather shown in FIGS. 1 and 2.

FIG. 4 is a side elevational view, showing in schematic form, a portion of a draper belt constructed in accordance with the prior art.

FIG. 5 is a perspective view showing a portion of the prior art draper belt shown in FIG. 4 as it can appear after having been torn or damaged.

FIG. 6 is a perspective view showing a portion of the novel draper belt of the present invention.

FIG. 7 is an isometric view of the novel draper belt of the present invention shown in FIG. 6.

FIG. 8 is a schematic diagram of the belt suggesting the belt plies and ply arrangements.

### DETAILED DESCRIPTION

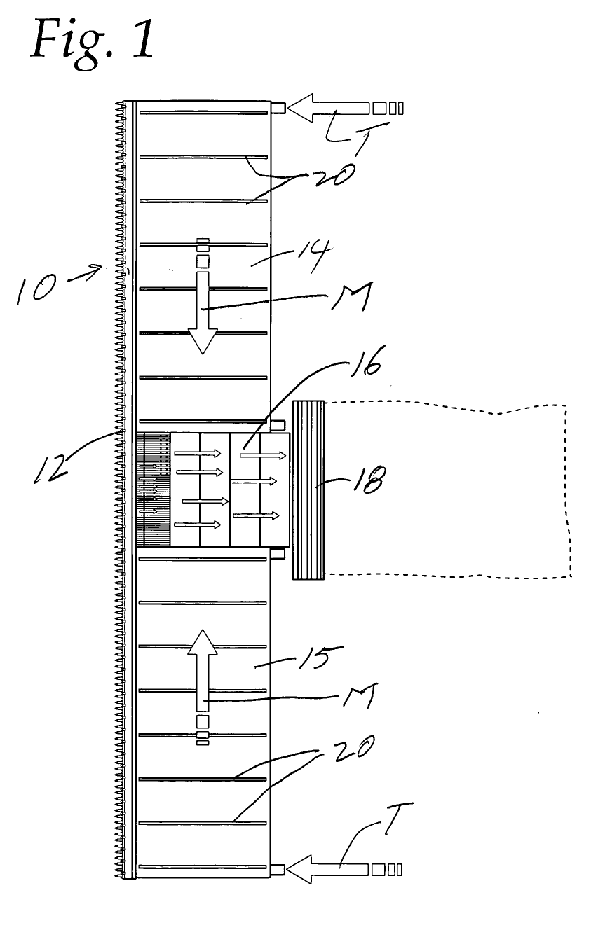

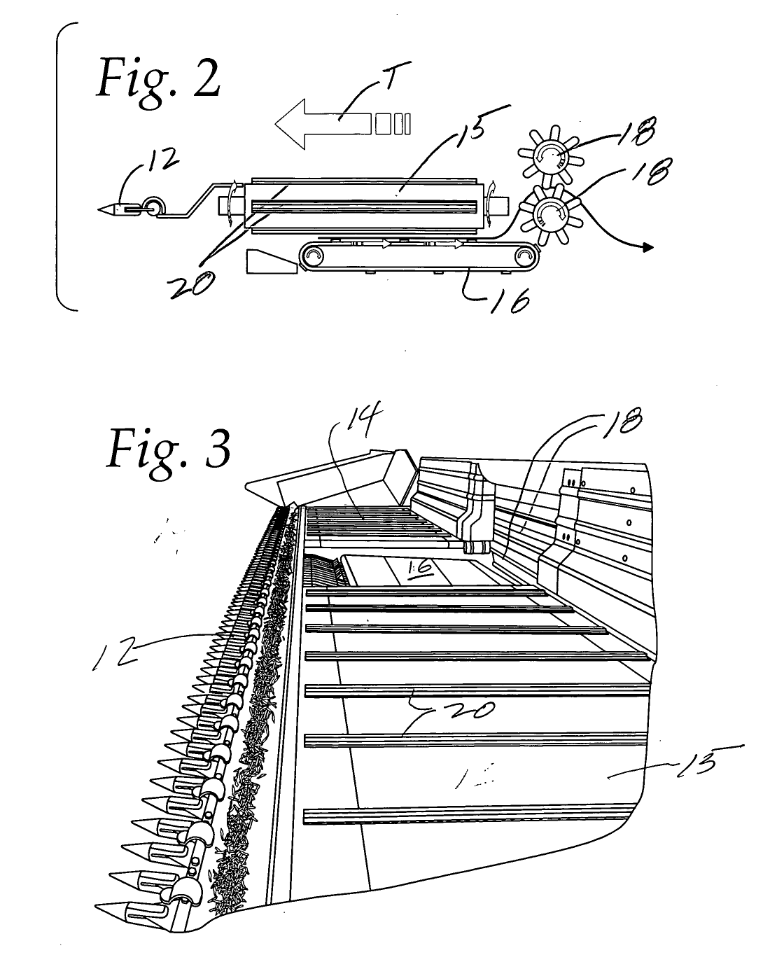

Turning more particularly to the drawings, there is shown in FIGS. 1-3, a swather farm implement 10 of the sort used to harvest hay. This swather (presumed to be moving in the direction of travel T as indicated by the arrows in FIGS. 1 and 2) includes a cutter bar 12, behind which conveyor belts or draper canvases 14 and 15 receive the cut and fallen material from the cutter bar 12. These draper belts 14 and 15 convey the cut material in the direction indicated by the arrows M in FIG. 1 to a center portion of the machine 10 where the material is received and conveyed rearwardly by another belt 16. The material can be passed through crimping rollers 18 and is ejected from the machine as indicated in FIG. 2 or it can be discharged directly to the ground. Alternatively, the cut material may be conveyed to the either side of the header for discharge.

To discourage material from slipping on the belts 14 and 15, the belts 14, 15 and 16 are each provided with cleats 20 at regularly spaced intervals. These cleats are attached to the belt by any known means such as an adhesive which is spread entirely through and over the belt-cleat interface area. Alternatively, the cleats can be integrally molded with the belt.

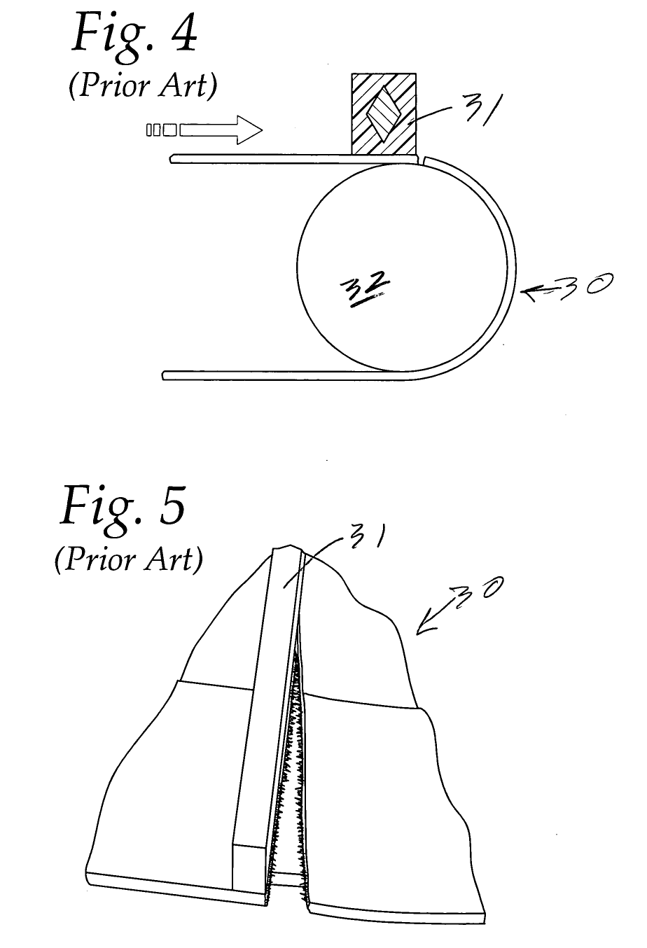

As indicated in FIGS. 4 and 5, the prior art draper belts 30 are prone to damaging separation or tearing. This separation often occurs adjacent a prior art cleat 31 because the belt is subject to stress spikes at the cleat leading edge. Relatively large amounts of stress are imparted to the belt adjacent the cleat 31 as the belt and cleat travel over the belt-mounting roller 32 which has a constricted diameter.

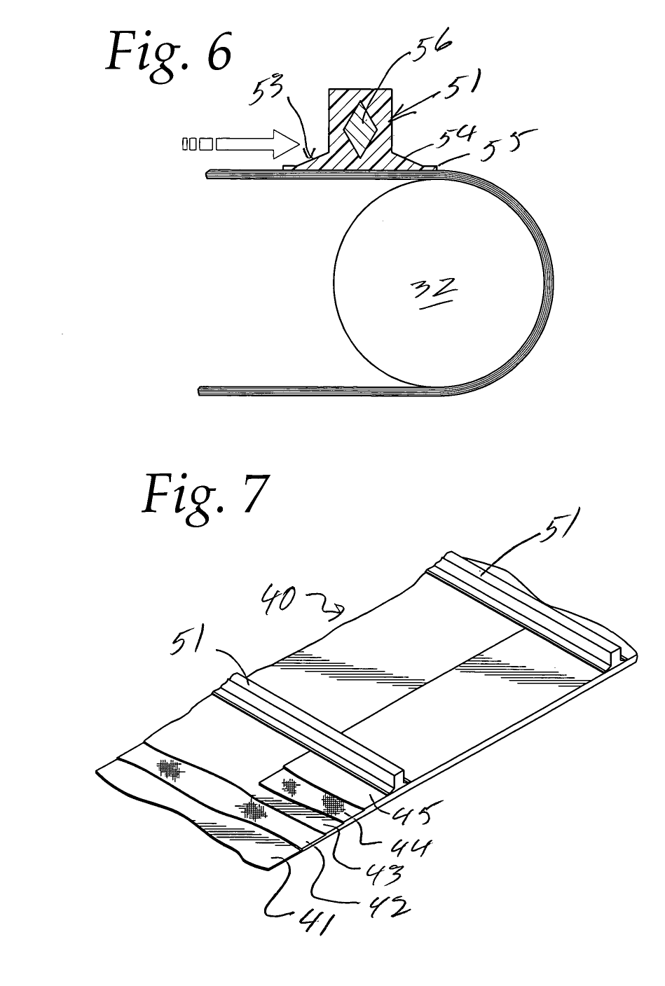

To discourage this damage or tearing and to enhance durability and belt edge regidity in accordance with the invention, the novel belt of the present invention 40 is provided. As shown in FIGS. 6,7, and 8, the novel belt comprises a first ply 41 formed of synthetic/natural rubber; a second ply 42 formed of synthetic/natural fiber woven fabric; and a third ply 43 formed of synthetic/natural rubber. This third ply 43 can be about twice as thick at the belt edges as it is at the belt mediate portion.

To reinforce the belt edges in accordance with the invention, a reinforcing fourth ply 44 formed of synthetic/natural fiber woven fabric and a fifth ply 45 formed of synthetic/natural rubber each extend span wise inwardly from the outer belt edges by an amount preferably about 15% on each side, for a total of both sides of about 20% to 40%, and preferably about one-third, of the belt span dimension. Belt tearing is discouraged by providing different material in the belt base ply and in the side reinforcement laminate. The synthetic/natural rubber is used to protect the synthetic/natural fiber woven fabric from damage arising from the material being conveyed, and from the roller or other structure of the equipment. The synthetic/natural rubber is also used to bond the plies of synthetic/natural fiber woven fabric.

To extend the region of the belt which is subjected to stress and strain as the cleat 51 and belt turn over a mounting roller 32 as shown in FIG. 6, the novel cleat 51 is provided with a longitudinally extended base 53. Here, this base 53 includes an intermediate portion 54 of gradually diminishing thickness, and a terminal formation 55 extending from the intermediate portion 54, as particularly shown in FIG. 6. The cleat 51 can be formed of any suitable material such as styrene butadyrene or acrylo-nitrile material and includes a reinforcing fiberglass bar 56, preferably of diamond shape as also suggested in FIG. 6.

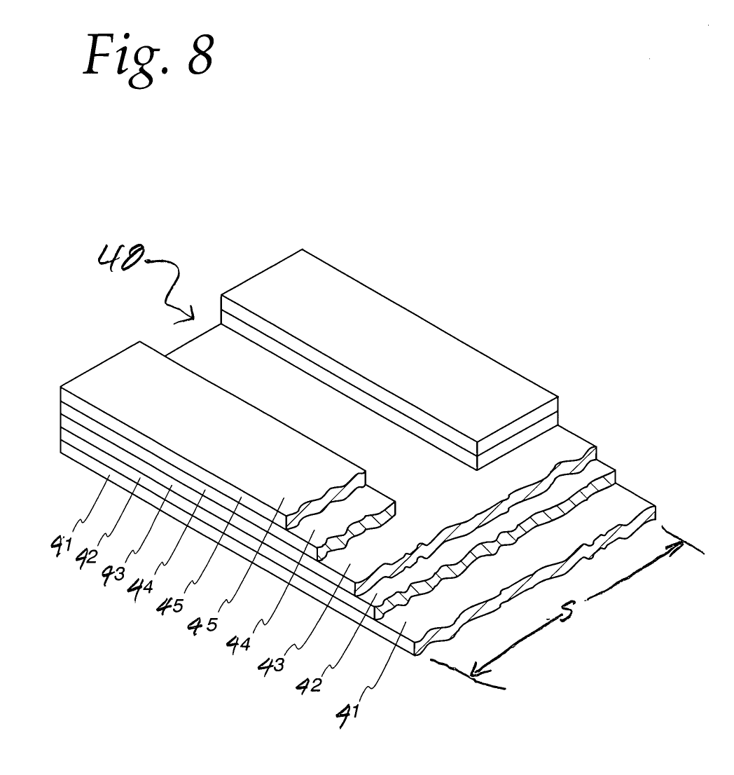

The novel belt 40 and its cleats 51 are shown in further detail in FIGS. 7 and 8. To discourage wear and tear and to further strengthen the belt edges in accordance with the invention, the belt 40 includes a protective rubber base 41 and an overlying ply of protective rubber reinforcing material 42. This reinforcing material 42 can consist of a flexible tensile reinforcing material such as Nylon, Polyester, Cotton or other load bearing tensile member and may, if desired, include a substrate of filament or spun polyester, nylon, cotton, or other materials, obtainable from any of a number of known sources. The upper layer of spun or filament fabric 42 extends the full width of the belt or draper. The fabric includes a great number of individual fibers of finite length which have been previously woven into a yarn, in known manner. The bottom substrate or ply 41 of the belt 40 includes a styrene butadyrene or acrylonitrile butadyrene material, or it can include a suitable natural rubber.

The following is claimed as invention:

1. A draper belt comprising a bi-edged belt of predetermined width, and at least one reinforcing ply affixed to an outer surface of the underlying belt adjacent to a belt edge.

2. A draper belt according to claim 2 wherein said reinforcing ply includes material having filaments of extended length.

3. A draper belt according to claim 1 wherein said draper belt includes a plurality of cleats, and wherein at least one cleat is provided with a base for attachment to the belt, the cleat base being of extended dimension in the direction of travel of the belt.

4. A draper belt comprising a belt and a plurality of cleats affixed to said belt, wherein at least one cleat is provided with a base for attachment to the belt, the cleat base being of extended dimension in the direction of travel of the belt.

5. A draper belt, comprising in combination, a first ply of a first material,
a second ply of a second material,
a third ply of a first material,
a fourth ply of a third material, and
a fifth ply of a first material.

6. a draper belt according to claim 5 wherein the draper belt has a span wise dimension of predetermined extent,
wherein the first, second and third plies extend over the entire span wise dimension of the draper belt to comprise a belt body,
and wherein the fourth and fifth plies extend over less than the entire span wise dimension of the draper belt to form a reinforcing side laminate for inhibiting belt edge wear or separation.

7. A draper belt according to claim 5 wherein said first material comprises a rubber covering.

8. A draper belt according to claim 6 wherein at least one reinforcing side laminate ply comprises a material different from the base belt.

9. A draper belt according to claim 5 wherein said belt is endless in configuration and accordingly has an outer surface and an inner surface,
and wherein one ply is located adjacent the outer surface so as to provide a uniform, unstepped belt inner surface whereby to encourage uniform span wise belt inner surface engagement by a belt drive roller.

10. A draper belt according to claim 6 wherein said fourth and fifth plies forming said side laminates each extend inwardly from a belt outer edge over about 15% on each side, for a total of both sides of from 25% to 40% of the span wise dimension of the belt.

11. A draper belt according to claim 10 wherein said belt is provided with two said side laminates, each side laminate extending span wise inwardly from a belt outer edge.

12. A draper belt having a predetermined span wise dimension and a cleat extending substantially continuously across a mediate said span wise dimension of said belt,
the cleat comprising, in combination, an upper body portion having a predetermined thickness measured in the direction of the travel,
and a lower bottom extending forwardly and rearwardly from the upper body portion in the direction of belt travel.

13. A cleat for a draper belt comprising, in combination
an upper body portion having a predetermined thickness measured in the direction of belt travel,
a chamfered transition portion extending forwardly and rearwardly from the cleat upper body portion in the direction of belt travel, and
a stepped base portion extending forwardly and or rearwardly from the transition portion in the direction of belt travel.

14. A cleat according to claim 13 wherein said base portion has an upper surface oriented substantially parallel to the outer surface of a belt to which the cleat is attached.

15. A cleat for a draper belt according to claim 13 wherein said upper body portion, said chamfered transition portion, and said stepped base portion are arranged so that an initial flex load absorption point is provided at the conjunction of said belt and a leading edge of the cleat stepped base portion,
a second flex load absorption point is provided at the conjunction of the stepped base portion and the chamfered transition portion, and
a primary flex load absorption point is provided at the conjunction of the chamfered transition portion and the cleat body portion.

16. A cleat for a draper belt according to claim 13 wherein said cleat body potion is defined by forward and rearward surfaces extending substantially perpendicularly to an underlying belt outer surface.

17. A cleat for a draper belt according to claim 14 wherein said forward and rearward surfaces of said cleat body portion each form angles with said underlying belt outer surface of about 88°.

18. A cleat for a draper belt according to claim 13 further including a reinforcing rod extending within said cleat.

19. A cleat for a draper belt according to claim 18 wherein said cleat is formed of a resilient material, and wherein said reinforcing rod is surrounded by at least ⅛″ of resilient material.
